(19) United States
(12) Patent Application Publication
(10) Pub. No.: US 2013/0173808 A1
(43) Pub. Date: Jul. 4, 2013

(54) APPARATUS AND METHOD FOR PROVIDING MIXED CONTENT BASED ON CLOUD COMPUTING

(71) Applicants: ELECTRONICS AND TELECOMMUNICATIONS RESEARCH INSTITUTE, Daejeon-si (KR); UNIVERSITY-INDUSTRY COOPERATION GROUP OF KYUNG HEE UNIVERSITY, Gyeonggi-do (KR)

(72) Inventors: Chang-Woo YOON, Daejeon-si (KR); Tae-Hee LEE, Gyeonggi-do (KR); Eui-Nam HUH, Gyeonggi-do (KR); Hyun-Woo LEE, Daejeon-si (KR)

(73) Assignees: UNIVERSITY-INDUSTRY COOPERATION GROUP OF KYUNG HEE UNIVERSITY, Gyeonggi-do (KR); ELECTRONICS AND TELECOMMUNICATIONS RESEARCH INSTITUTE, Daejeon-si (KR)

(21) Appl. No.: 13/728,127

(22) Filed: Dec. 27, 2012

(30) Foreign Application Priority Data
Dec. 30, 2011 (KR) 10-2011-0147616

(51) Int. Cl. H04L 12/24

(52) U.S. Cl. CPC H04L 41/00
USPC 709/226

(57) ABSTRACT

There are provided a concept of mixing and synchronizing a plurality of pieces of content and of providing mixed content to an N-screen terminal, a method for overcoming limitations of a mobile terminal using a thin-client technique based on cloud computing and an apparatus for providing mixed content based on cloud computing. The apparatus for providing mixed content based on cloud computing includes a content server configured to, in response to a content request, execute a piece of content and provide content execution results, a content access middleware configured to allocate one or more virtual terminals to the content server, receive the content execution results from the content server and synchronize the content execution results, and a virtual convergence gateway server configured to receive the synchronized content execution results, generate mixed content and provide the mixed content to the user terminal using a split-screen method and a multi-screen method.

### CROSS-REFERENCE TO RELATED APPLICATION

This application claims the benefit under 35 U.S.C. §119(a) of Korean Patent Application No. 10-2011-0147616, filed on Dec. 30, 2011, the disclosure of which is incorporated by reference in its entirety for all purposes.

### BACKGROUND

1. Field

The present invention is related to an N-screen service for providing mixed-content based on cloud computing in a thin client environment.

2. Description of the Related Art

With the advent of the cutting-edge mobile terminals, including smart phones and tablet PCs, demands for various types of content have increased. In order to meet the demands and provide better mobile services, new concepts like a thin-client service and an N-screen service have been introduced.

Cloud computing is a technology for providing IT-related functions in the form of service. That is, it integrates computers resources, each of which is physically located in a different place, using virtualization technologies while the conventional computing environment depends on independent hardware performance of a terminal. Specifically, the cloud computing is a user-friendly computing environment where a user may store a program or a file in an Internet-connectable mass computer, instead of individually storing it in a personal PC or a corporate server, and execute an application, such as a web browser, to perform a desired task using various terminals including a PC and a mobile terminal.

A thin client is a user terminal consisting of indispensible devices, and a central server stores and processes data and executes software instead of the thin client. A thin-client system has been realized using desktop virtualization, a representative technology of cloud computing. Using the desktop virtualization technology, a client is managed through a virtual machine executed in a server or a session management function of a server operating system, and a virtual terminal exclusively executes the software and transmits the execution screen to a terminal of the client. This cloud computing-based thin client technology helps to overcome some disadvantages of a mobile device which relatively lacks resources.

The development of the cloud-computing technology has brought about an N-screen content service. The N-screen content service refers to a synchronization service which allows a user to enjoy content continuously, such as watching a piece of content using a TV at home, then on a smart phone while commuting and then a PC after arriving at work.

The N-screen service in a cloud computing environment is focused on providing one piece of content to one user terminal, but not on providing various pieces of content to an N-screen terminal simultaneously. A technology for such service may be significantly useful for a thin-client user and, using the technology, the thin-client user is able to receive various services in one terminal or on one platform. The N-screen service currently used in thin clients still depends on a platform, and there is no system for providing a mixture of various pieces of content to a user. In addition, the N-screen service has not efficiently been converged with cloud computing technologies, and there is a lack of dynamic resource allocation algorithms which are necessary to deal with numerous client terminals, each having a different bandwidth and processor performance.

### SUMMARY

The following description relates to solve the above drawbacks. It is related to a concept of mixing and synchronizing various pieces of content and providing the mixed content to an N-screen terminal and aims to provide a system for providing mixed content based on cloud computing in order to overcome disadvantages of a conventional mobile terminal and an apparatus using the same.

In one general aspect of the present invention, there is provided an apparatus for providing mixed content based on cloud computing, and the apparatus includes one or more content servers configured to store a plurality of pieces of content, allocate one or more virtual terminals in response to a received content call for a piece of content, execute the piece of content in the one or more allocated virtual terminals and provide content execution results; a content access middleware configured to search for the piece of content in the content server in response to a received content request for the piece of content, select the piece of content, generate the content call to allocate one or more virtual terminals in consideration of the selected piece of content and to request content execution results, transmit the content call to the content server, receive the content execution results from the content server and synchronize the content execution results; and a virtual convergence gateway server configured to manage a multiple-user profile storing user information and user-terminal information, transmit the content request for the piece of content from a user terminal to the content access middleware, receive the synchronized content execution results from the content access middleware, mix the synchronized content execution results to generate mixed content and provide the mixed content to the user terminal using a split-screen method and a multi-screen method based on the multiple-user profile.

The apparatus for providing mixed content based on cloud computing allocates one or more virtual terminals using a virtual-terminal allocation algorithm so as to use the user terminal as a thin client. The virtual-terminal allocation algorithm dynamically allocates a virtual terminal to a server, based on a resource state of a server and a required a resource amount of the virtual terminal.

In addition, the apparatus for providing mixed content based on cloud computing synchronizes and mixes a plurality of pieces of content to generate one mixed content and provide the mixed content to an N-screen of the user terminal using methods of a split screen and multiple-screens.

### BRIEF DESCRIPTION OF THE DRAWINGS

FIG. 1 is a diagram illustrating an example of a configuration of an apparatus for providing mixed content based on cloud computing.

FIG. 2 is a flow chart illustrating a method for providing mixed content based on cloud computing according to an exemplary embodiment of the present invention.

FIG. 3 is a graph illustrating a formula to calculate a threshold value positioned on the side of a virtual-terminal allocation algorithm according to an exemplary embodiment of the present invention.

FIG. 4 is a graph illustrating a formula to calculate a threshold value positioned in the middle of a virtual-terminal allocation algorithm according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be appreciated by those of ordinary skill in the art. Descriptions of well-known functions and structures are omitted to enhance clarity and conciseness.

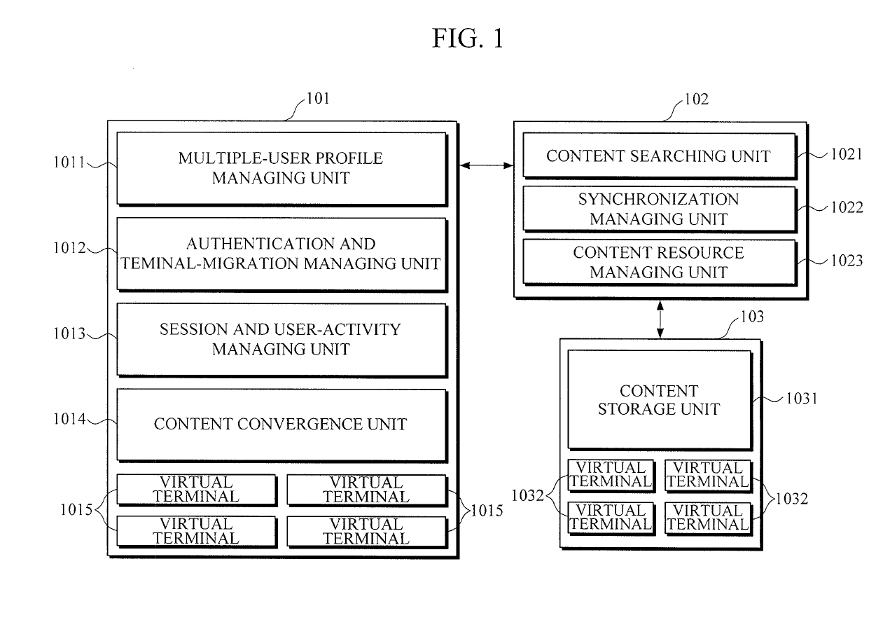

FIG. 1 is a diagram illustrating a configuration of an apparatus for providing mixed content based on cloud computing according to an exemplary embodiment of the present invention.

Referring to FIG. 1, the apparatus for providing mixed content based on cloud computing according to an exemplary embodiment of the present invention includes a virtual convergence gateway server 101 configured to store and manage a user profile and a user-terminal profile and provide mixed content, a content access middleware 102 configured to connect the virtual convergence gateway 101 and a content server 103, and the content server 103 configured to store and provide one or more pieces of content.

The content server 103 includes a content storage unit 1031 configured to store a plurality of pieces of content and one or more virtual terminals 1032 configured to execute a piece of content within the content server 103. The content server 103 may be one server or a plurality of servers, and it provides pieces of content regardless of the types and number of the pieces of content. The content server 103 allocates one or more virtual terminals in response to a received content call for a piece of content. The content call is received from the content access middleware 102.

The virtual terminals 1032 are computers which are configured by a hypervisor within the content server 103.

The hypervisor is thins-layer software that controls accesses of different operating systems to various computer resources such as processors and memory. In other words, the hypervisor is software which enables a plurality of operating systems to operate in one computer system. The hypervisor is used not only as a kind of middleware between a Central Processing Unit (CPU) and operating systems but also as a virtualization engine capable to configure a virtual computer that uses a plurality of different operating systems in one computer.

The virtual terminals 1032 are not physical computers but computers which are logically realized within a server using resources provided from the server, such as CPU resources, memory resources, storage resources, Graphic Processing Unit (GPU) resources and network resources. That is, the virtual terminals 1032 are virtual computers, which are configured in a software manner in an actual computer system, to enable a single physical computer to be partitioned into smaller virtual computers for multiple users to use the same computer simultaneously. The virtual terminals 1032 internally execute content and provide the content execution results of the piece of content to the content access middleware 102.

The content access middleware 102 includes a content searching unit 1021, a synchronization managing unit 1022 and a content resource managing unit 1023.

The content searching unit 1021 searches the content server 103 for a piece of content based on user information, user-terminal information and content information provided from a multiple-user profile managing unit 1011 of the virtual convergence gateway server 101 and selects the piece of content.

The synchronizing managing unit 1022 synchronizes the content execution results provided from the content server 103. The apparatus for providing mixed content based on cloud computing according to the exemplary embodiment of the present invention provides mixed content using a split-screen method and/or a multi-screen method while the conventional method for providing content to one terminal has been commonly used. The mixed content is generated such that a content convergence unit 1014 of the virtual convergence gateway server 101 mixes a plurality of pieces of content which fit a user's purpose. In order to proceed with the above process, each of the pieces of content should be synchronized in terms of structures, formats, transmission speeds and reproduction timing.

The content resource managing unit 1023 dynamically allocates one or more virtual terminals 1032 to the content server 103. That is, the content resource managing unit 1023 generates a content call to allocate one or more virtual terminals 1032 using resources of the content server 103 based on the multiple-user profile information, and then transmit the content call to the content server 103. The content call further includes a request for content execution results. The content resource managing unit 1023 determines resources, such as CPU resources, memory resources, GPU resources and network resources, in consideration of a server state and a required resource amount of the piece of content and allocates the determined resources.

The virtual convergence gateway server 101 includes the multiple-user profile managing unit 1011, an authentication and terminal-migration managing unit 1012, a session and user-activity managing unit 1013, the content convergence unit 1014 and one or more virtual terminals 1015.

The multiple-user profile managing unit 1011 stores and manages a user profile to provide a piece of content which fits a user's purpose. Information to be stored in the user profile includes feature information of various user-registered terminals, such as performance, operating systems and communication environments, and content information about pieces of content which are possessed or currently used by a registered user. Such information helps to provide a good-quality service to a user.

The authentication and terminal migration managing unit 1012 authenticates a piece of content and a user, converts a format of the piece of content and manages compatibility and correlation between user terminals. In the case of a N-screen service, it is very inconvenient for a user to repetitively log in/out and search for a piece of content whenever the user replaces a user terminal with another. Such inconvenience may be addressed if it is possible to authenticate a user and a user-terminal based on a user profile.

Each virtual terminal 1015 of the virtual convergence gateway server 101 performs the same function of each virtual terminal 1032 of the content server 103. A plurality of the virtual terminals 1015 provide a user terminal with the content execution results of mixed content which is generated during a content convergence process. In the present invention, the mixed content is generated based on the content execution results provided from a plurality of the virtual terminals 1032 of the content server 103 so that the mixed content does not need a large amount of server resources necessary for execution. Accordingly, resources of one or more virtual terminals 1015 are statically allocated.

The session and user-activity managing unit 1013 manages a session activated by terminals and users. In addition, the session and user-activity managing unit 1013 connects, terminates and manages a server connection session between multiple users and multiple user terminals.

In response to a user's content request, the content convergence unit 1014 mixes a plurality of pieces of content to generate mixed content. That is, the content convergence unit 1014 mixes a plurality of synchronized content execution results, which serve the user's content request and purpose, in order to generate the mixed content. The generated mixed content is provided to a user terminal using a split-screen method and/or a multi-screen method.

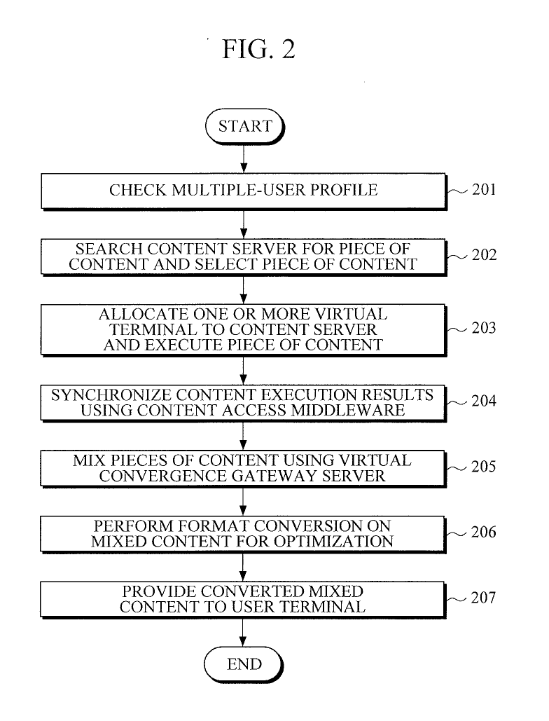

Referring to FIG. 2 is a flow chart illustrating a method for providing mixed content based on cloud computing according to an exemplary embodiment of the present invention.

Referring to FIG. 2, the method for providing mixed content based on cloud computing is as below: In response to a user's content request, user information, user-terminal information and content information of a multiple-user profile are checked in 201. A virtual convergence gateway server controls a content access middleware to search a content server for a piece of content requested from the user and select the corresponding piece of content in 202. A content resource managing unit of the content access middleware allocates one or more virtual terminals to the content server using a virtual-terminal allocation algorithm and executes the selected piece of content in one or more allocated virtual terminals in 203. The content execution results of the piece of content executed in one or more allocated virtual terminals are transmitted to a synchronization unit of the content access middleware and then synchronized 204. The synchronized content execution results are transmitted to a content convergence unit of the virtual convergence gateway server and then mixed to become mixed content in 205. In order to have the definition, capacity and number of pixels adequate to a user terminal, the mixed content is converted into a different format of the based on the user terminal information provided from the multiple-user profile during an optimization process in 206. The content execution results of the mixed content which have gone through the optimization process are transmitted to the user terminal in 207.

In addition, it is necessary to store user information and user terminal information in the user profile and authenticate a user for security before checking the multiple-user profile to see the user information and the user terminal information.

In the user profile, user information, user terminal information and content information are stored. Therefore, user's personal information and detailed information about registered user-terminals, such as types, operating systems, communication environments, display size and definition, are stored, classified and managed in the user profile. In addition, real-time information about pieces of content which are possessed or currently used by a user is stored in the user profile.

In response to a user's content request, a user authentication process is required to check the user profile as well as for the security reasons. The process for authenticating a user and a user terminal prevents any access of an unallowed person whereby a leakage of personal information is avoidable. In addition, the authentication of previously-registered users and user-terminals is useful for checking the user profile and for minimizing inconvenience led by repetitively logging in/out and searching for a piece of content when a currently-used user terminal is replaced with another, thereby enhancing user convenience.

If a user requests a content service, the virtual convergence gateway server controls the multiple-user profile managing unit to check detailed information of a currently-used user terminal and content usage history of the user terminal. The virtual convergence gateway server selects a piece of content which corresponds to a user-requested content type based on the above-described information and determines the piece of content in consideration of its process state and other information.

The content information determined through the above-described process is provided to a content searching unit of the content access middleware and is searched in a content server. The content searching unit searches for the piece of content in all accessible content servers, rather than a single content server, and selects the piece of content. The content resource managing unit allocates one or more virtual terminals to the content server based on the selected piece of content, and controls execution of the selected piece of content in one or more virtual terminals.

The content execution results provided from a plurality of virtual terminals of the content server may be related to one piece of content or a plurality of pieces of content according to a user's content request. If two or more content execution results are selected, a synchronization process is necessary to mix the content execution results in order to generate mixed content. That is, different pieces of content which execute differently in different operating systems are synchronized in terms of structures, formats, transmission speeds and reproduction timing.

The content execution results synchronized by the synchronization managing unit are transmitted to a content convergence unit of the virtual convergence gateway. The corresponding content execution results are mixed to serve a user's request and purpose, whereby mixed content is generated. The mixed content is a mixture of two or more pieces of content to various functions and information while the conventional method is related to a technology for providing one piece of content to one terminal. For example, it is possible to mix three different pieces of content, such as a real-time baseball game broadcast, baseball rule information and a broadcast storage. In this case, while watching the baseball game, a user may receive real-time information about a baseball-player who makes a hit or information about a play against the baseball rules if this kind of play is made during the baseball game. In addition, it is possible to reproduce a missed section of a broadcast while watching it in real-time. As above, the method for providing mixed content helps to provide a higher-quality service, compared to the conventional method.

In the present invention, a user terminal is considered a thin client. Accordingly, one or more virtual terminals are generated in a content server and then allocated to a user terminal. The content resource managing unit of the content access middleware controls a hypervisor of the content server to allocate one or more virtual terminals to the user terminal in consideration of information about a selected piece of content and user terminal information. The content resource managing unit allocates necessary resources of the content server, such as CPU resources, memory resources, storage resources, GPU resources and network resources, to serve a user's request.

A process is further included before the mixed content is provided to the user terminal. As each user terminal may have different performance, communication environment and operating system, it is hard to provide the same piece of content to different user terminals. Yet, if it is possible to check user-terminal information stored in a user profile while the piece of content is converted into a format to have definition and content capacity, which are adequate to a screen size and transmission speeds of the user terminal, a higher-quality service may be provided. For this reason, the authentication and terminal-migration managing unit converts the mixed content into a format to have the definition, capacity and number of pixels adequate to the user terminal based on the user profile so that the format of the mixed content may be optimized for the user terminal.

One or more virtual terminals of the virtual convergence gateway server execute the mixed content and transmit the content execution results of the mixed content to the user terminal. The mixed content may be displayed in the user terminal using a split-screen method and a multi-screen method. The split-screen method is about dividing a screen of the user terminal screen into two or more regions so as to display various pieces of content of the mixed content in each of the regions. The multi-screen method is about using two or more user terminals to display various pieces of content of the mixed content on each screen of different user terminals simultaneously. The present invention is not limited to only one of the above methods, but it may use either or both of the above methods or otherwise a conventional method which uses only one screen.

One or more virtual terminals generated as described above are allocated using a static allocation method and a dynamic allocation method. One or more virtual terminals of the virtual convergence gateway server are allocated using the static allocation method for using peak load. Each virtual terminal of the virtual convergence gateway server does not need abundant resources since it is based on content execution results received from one or more virtual terminals of the content server. On the other hand, one or more virtual terminals of the content server is allocated using the dynamic allocation method for setting a capacity of each virtual terminal according to workload and then searching for an adequate server to which the corresponding virtual terminals are migrated.

The present invention is focused on an efficient dynamic allocation of one or more virtual terminals in order to meet the user's Quality of Experience (QoE) requirements and keep to the Service Level Agreement (SLA). The method for dynamically allocating one or more virtual terminals according to an exemplary embodiment of the present invention reduces the number of servers, controls a delay time for receiving service information and uses load balancing, thereby leading to energy and cost savings, improving a response time and adjusting overall physical resource usage.

The above-described objectives may be achieved using linear programming. In order to enhance allocation efficiency, the linear programming limits a delay time for receiving service information, resource usage and CPU usage. If the service delay time is limited, a service response time may be reduced. In addition, if usage of each resource is limited, a more efficient overall resource usage may be realized and resource overuse may be prevented. A resource allocation algorithm according to an exemplary embodiment of the present invention has employed the dynamic allocation method for calculating workload to set capacity of each virtual terminal and then migrating each virtual terminal to another server in consideration of a server state.

The linear programming is one of Operation Research (OR) methods which have been developed to deal with resource and/or equipment problems occurring when producing several kinds of outcomes using limited resources or equipments. That is, the linear programming is a mathematical method for determining a linear constraint to determine an objective function whereby an optimal solution is obtained.

The linear programming employed by a virtual terminal allocation algorithm according to an exemplary embodiment of the present invention has linear constraint functions to minimize the number of servers, map each virtual terminal, limit a required resource amount of each virtual terminal and limit a network delay time. A linear constraint to minimize the number of necessary servers is represented by Equation 1, and a linear constraint to map each virtual terminal to one server is represented by Equation 2.

$$\begin{matrix}min {\sum }_{p ∈ P} {y}_{p} & [ Equation 1 ] \\ {\sum }_{p ∈ P} {x}_{pv} = 1 ∀ v ∈ V & [ Equation 2 ]\end{matrix}$$

A linear constraint to ensure that a required resource amount of each virtual terminal does not exceed a capacity of a server is represented by Equation 3.

$${\sum }_{v ∈ V} {u}_{v r} {x}_{p v} \leq {c}_{pr} {y}_{p} ∀ p ∈ P , ∀ r ∈ R \qquad [ Equation 3 ]$$

A linear constraint to limit a network delay time is represented by Equation 4.

d_{I}≦T [Equation 4]

A linear constraint to limit overall resource usage is represented by Equation 5, and a linear constraint to adjust CPU resource usage of the server is represented by Equation 6.

$$\begin{matrix}{\sum }_{p ∈ P} r u {c}_{pv} {x}_{p v} \leq {T}_{1} ∀ v ∈ V & [ Equation 5 ] \\ {\sum }_{p ∈ P} {s}_{p v} {x}_{p v} \leq {T}_{2} ∀ v ∈ V & [ Equation 6 ]\end{matrix}$$

In the above, yₚ is the number of servers; χₚᵥ is a variable with respect to a server p of a virtual terminal v, P is the number of physical servers; V is the number of virtual terminals; R is resources such as CPU resources, memory resources, GPU resources or network resources; uᵥᵣ I is resource usage of the virtual terminal; Cₚᵣ is a resource capacity of a server; d_{I} is a delay time of a service request; T₂ is a network delay threshold; rucₚᵥ is an amount of resources being used by the virtual terminal in the server; sₚᵥ is an amount of CPU resources being used by the virtual terminal in the server; T₁ is a threshold representing an overall resource state; and T₂ is a threshold representing an amount of remaining CPU resources.

The linear constraint to limit a network delay time of each virtual terminal employs a non-synchronous integration method, a synchronous integration method and a sequential-service integration method.

In the case of the non-synchronous integration method, virtual terminals are unable to communicate with each other. A linear constraint to limit a network delay of each virtual terminal is represented by Equation 7.

$$I = \{ {v}_{1} , {v}_{2} , … , {v}_{n} \} \\ {\sum }_{p ∈ P} {d}_{p {e}_{i}} {x}_{p {v}_{i}} \leq {T}_{{v}_{i}} ∀ {v}_{i} ∈ I \qquad [ Equation 7 ]$$

In the case of the synchronous integration method, a screen update of the i-th virtual terminal is synchronized and then transmitted to a user. A linear constraint to limit a network delay time of this case is represented by Equation 8.

$${\sum }_{p ∈ P} {d}_{p {e}_{i}} \leq min ( {T}_{{v}_{i}} ) ∀ {v}_{i} ∈ I \qquad [ Equation 8 ]$$

In the case of the sequential-service integration method, an output value of a service executed in vᵢ is identical to an input value of another service executed in vᵢ+1. A linear constraint to limit a network time delay of this case is represented by Equation 9.

$${\sum }_{p ∈ P} {d}_{p {e}_{1}} {x}_{{pv}_{i}} \leq {T}_{{v}_{1}} \\ Given {P}_{1} {\sum }_{p ∈ P} ( {d}_{p {e}_{2}} + {d}_{{p}_{1} p} ) {x}_{{pv}_{2}} \leq {T}_{{v}_{2}} - {T}_{{v}_{1}} \\ … \\ Given {P}_{n - 1} {\sum }_{p ∈ P} ( {d}_{p {e}_{i}} + {d}_{{p}_{i - 1} p} ) {x}_{{pv}_{i}} \leq {T}_{{v}_{i}} - {T}_{{v}_{i - 1}} \qquad [ Equation 9 ]$$

In this case, a limited delay time for allocating vᵢ₊₁ is calculated by deducting Tᵥ_{ᵢ} out of Tᵥ_{ᵢ₊₁}. I is a requested service; dₚₑ_{ᵢ} is a network delay time between a Server p and an external server eᵢ; dₚ_{_{i−1}}ₚ is a network delay time between a server and a server p; and Tᵥ_{ᵢ} is a limited delay time allocated to a virtual terminal i.

If a piece of content i and a physical server j are given in response to a requested service, each of cᵢⱼ, mᵢⱼ, gᵢⱼ and bᵢⱼ represents an amount of resources, such as a CPU, a memory, a GPU and a network bandwidth, respectively. Herein, the physical server means an actually-installed server. If the piece of content is provided from the virtual terminal, the virtual terminal, an operating system and additional resource usage of server also need to be given. In addition, the piece of content i and a virtual terminal v may replace each other. Each of fcⱼ, fmⱼ, fgⱼ and fbⱼ represents an amount of unused resources, such as a CPU, a memory, a GPU and a network bandwidth, respectively, of a physical server. Any kind of resources has to be left with at least 25% of remaining capacity in order to buffer an unexpected amount of workload, and the remaining capacity should not be considered to measure an amount of unused resources. Therefore, the piece of content is able to be allocated to an actual terminal only when Equation 10 is satisfied.

cᵢⱼ≦fcⱼ&mᵢⱼ≦fmⱼ&gᵢⱼ≦fgⱼ&bᵢⱼ≦fbⱼ [Equation 10]

An average amount of remaining resources which is left after the piece of content i has been allocated to the physical server j is defined by Equation 11.

apᵢⱼ=(fc′ⱼ+fm′ⱼ+fg′ⱼ+fb′ⱼ)/4

fc′=fcⱼ−cᵢⱼ,f_{m′}ⱼ=fmⱼ−mᵢⱼ,fg′ⱼ=fgⱼ−gᵢⱼ,fb′ⱼ=fbⱼ−bᵢⱼ [Equation 11]

rucᵢⱼ is an amount of resources which is left after the piece of content i is allocated to the physical server j, and rucᵢⱼ is an effective value and defined by Equation 12.

rucᵢⱼ=(fc′ⱼ−apᵢⱼ)²+(fm′ⱼ−apᵢⱼ)²+(fg′ⱼ−apᵢⱼ)²+(fb′ⱼ−apᵢⱼ)² [Equation 12]

In this case, it is assumed that, if a piece of content is executed in one physical server, CPU resources are shared proportionally.(what??) Specifically, if the piece of content i is allocated to the physical server j, an amount of CPU resources is obtained according to Equation 13.

Central Processing Unit(CPU)Resources=(cᵢⱼ/(1−fc′ⱼ))×100% [Equation 13]

The superiority of the physical server j over the piece of content i may be defined by Equation 14. (or Superiority of the physical server j may be defined by Equation 14 in consideration of the piece of content i.???)

Sᵢⱼ=cᵢⱼ/(cᵢⱼ/(1−fc′ⱼ))=1−fc′ⱼ [Equation 14]

The present invention uses a heuristic to deal with a problem of virtual terminal allocation. Based on the above, each virtual terminal, to which each resources is allocated, is allocated to a physical server using a bin-packing problem. The bin-packing problem is solved using the heuristic. Although the heuristic is not the best solution, it is able to be realized within a given short time, compared to a linear programming, especially in a large-scale system.

Heuristics able to be used for allocating a virtual terminal are a first-fit decreasing heuristic, a best-fit decreasing heuristic, a worst-fit decreasing heuristic and an almost worst-fit decreasing heuristic. In the above-described heuristics, requirements of each virtual terminal are arranged in a decreasing order. The requirements are tuples which take into account resources (for example, a CPU, a memory, a GPU and a network bandwidth), and each of the tuples are arranged in a lexicographic order. After the arrangement, each virtual terminal is mapped according to a definition of a heuristic. In the case of the first-fit decreasing heuristic, each virtual terminal is mapped to the first server. In the case of the best-fit decreasing heuristic, each virtual terminal is mapped to a server which has the smallest capacity after every server has been mapped. In the case of the worst-fit decreasing heuristic, each virtual terminal is mapped to a server which has the largest capacity after every server has been mapped. In the case of the almost worst-fit decreasing heuristic, each virtual terminal is mapped to a server having the second-largest capacity after every server has been mapped.

In the linear constraints of the present invention, three different thresholds are used, including a network delay threshold T, a threshold of an overall resource state T₁, a threshold of remaining CPU resources T₂. The threshold is given according to QoS requirements of each piece of content. The threshold of remaining CPU resources T₂ is within a limited range of between 0.7 and 0.75. That is, the maximum CPU usage of an actual terminal is 70% to 75%. Remaining CPU resources is left in order to control any unexpected CPU burst. The threshold T₂ may be updated according to QoS requirements of each piece of content. If a CPU burst frequently occurs in a piece of content, the threshold T₂ of the piece of content is small. The value of an overall resource usage U is defined by Equation 15 in order to precisely calculate the threshold T₁.

$$U = {λ}_{c} ⌈ {\sum }_{{p}_{j} ∈ P} ( 1 - {fc}_{j} ) \times {oc}_{j} ⌉ + {λ}_{m} ⌈ {\sum }_{{p}_{j} ∈ P} ( 1 - {fm}_{j} ) \times {om}_{j} ⌉ + {λ}_{g} ⌈ {\sum }_{{p}_{j} ∈ P} ( 1 - {fg}_{j} ) \times {og}_{j} ⌉ + {λ}_{b} ⌈ {\sum }_{{p}_{j} ∈ P} ( 1 - {fb}_{j} ) \times {ob}_{j} ⌉ - {C}_{{p}^{′}} \qquad [ Equation 15 ]$$

In this case, each of ocⱼ, omⱼ, ogⱼ and obⱼ represents an amount of CPU resources, memory resources, GPU resources and network bandwidth resources of a server pⱼ, respectively. Each of λ_{c}, λₘ, λ_{g} and λ_{b} represents a pricing schema of a CPU unit, a memory unit, a GPU unit and a network-bandwidth unit, respectively. Cₚ′ represents maintenance costs of an activated server. For example, in the case of a heuristic which has a piece of content, a server and the threshold T₁ as one set, if the threshold value is continuously changed while the heuristic algorithm is being implemented, the value of an overall resource usage U is changed.

f(T₁)=U(0≦T₁≦1) [Equation 16]

If Equation 16 is an evaluation function, its objective is to calculate the value of T₁ in order to maximize the value of U. To put it simple, f(T₁) should be represented as a unimodal graph. If T₁ is considered as a standard point, an extremely low value of T₁ may cause trouble in the allocation of an appropriate virtual terminal while an extremely high value of T₁ may lead to allocation of an inappropriate virtual terminal. Both of the two cases are triggered by a small amount of used resources, meaning that more servers need to be used to meet the requirements of each virtual terminal. The present invention suggests an iterative method to precisely calculate a value of T₁. Specifically, a heuristic is implemented to simulate a process in which one or more virtual terminals are allocated using different values of T₁. According to a value of U, an interval is divided by half and then a subinterval in which a value of T₁ maximizes f(T₁) is selected.

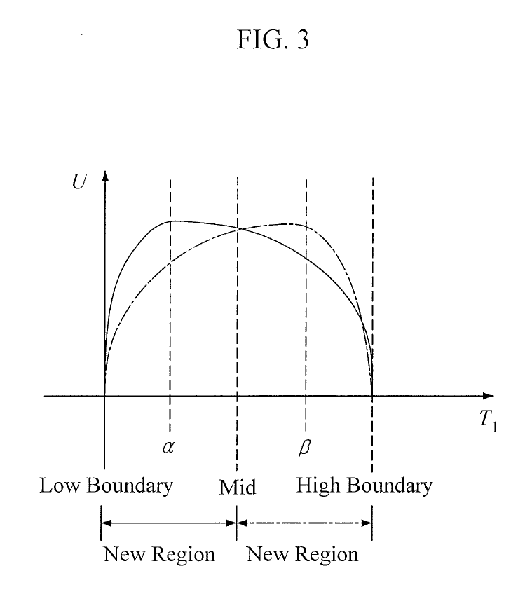

FIG. 3 is a graph illustrating a formula to calculate a threshold value existing on the side of a virtual-terminal allocation algorithm according to an exemplary embodiment of the present invention.

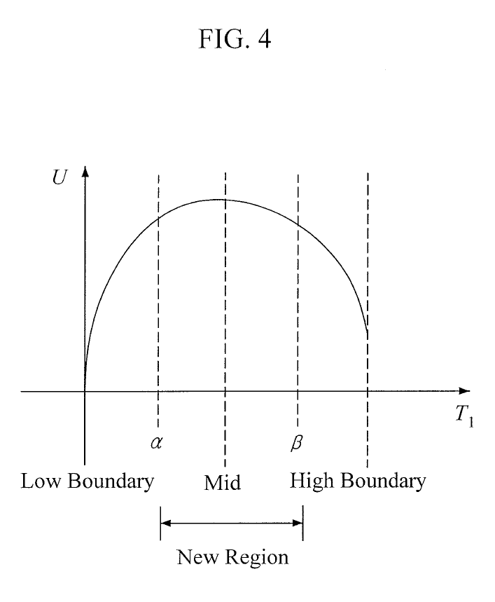

FIG. 4 is a graph illustrating a formula to calculate a threshold value existing in the middle of a virtual-terminal allocation algorithm according to an exemplary embodiment of the present invention.

As shown in FIGS. 3 and 4, α and β are mid-points of each of subintervals.

f(α)>f(Mid) [Equation 17]

f(β)>f(Mid) [Equation 18]

Referring to FIG. 3, when Equation 17 is satisfied, the current mid-point has to be set on a higher boundary and α needs to be set as a new mid-point. Similarly, when Equation 18 is satisfied, the current mid-point should be set on a lower boundary and β needs to be set as a new mid-point. Referring to FIG. 4, when both Equation 17 and Equation 18 are satisfied, α and β have to be set on a lower boundary and a higher boundary, respectively.

Regarding the T₁, the low boundary and the high boundary should be initialized to satisfy T₁=0 and T₁=1, respectively. Hence, T₁=0.5 may be satisfied at the mid-point between the low boundary and the high boundary. Values of the low boundary, the high boundary and the mid-point are continuously updated until an interval between the low boundary and the high boundary becomes narrow. During runtime, a value of T₁ is calculated at predetermined intervals, rather than continuously being updated.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing mixed content based on cloud computing, comprising:
one or more content servers configured to store a plurality of pieces of content, allocate one or more virtual terminals in response to a received content call for a piece of content, execute the piece of content in the one or more allocated virtual terminals and provide content execution results;
a content access middleware configured to search for the piece of content in the content server in response to a received content request for the piece of content, select the piece of content, generate the content call to allocate one or more virtual terminals in consideration of the selected piece of content and to request content execution results, transmit the content call to the content server, receive the content execution results from the content server and synchronize the content execution results; and
a virtual convergence gateway server configured to manage a multiple-user profile storing user information and user-terminal information, transmit the content request for the piece of content from a user terminal to the content access middleware, receive the synchronized content execution results from the content access middleware, mix the synchronized content execution results to generate mixed content and provide the mixed content to the user terminal using a split-screen method and a multi-screen method based on the multiple-user profile.

2. The apparatus of claim 1, wherein the content server comprises
a content storage unit configured to store the plurality of pieces of content; and
the one or more virtual terminals configured to execute the piece of content selected from the content storage unit.

3. The apparatus of claim 1, wherein the content access middleware comprises
a content searching unit configured to search for the piece of content stored in the content server in response to the received content request for the piece of content and select the found piece of content;
a synchronization managing unit configured to synchronize the content execution results provided from the content server; and
a content resource managing unit configured to allocate the one or more virtual terminals to the content server, execute the piece of content in the one or more allocated virtual terminals and transmit a content call for the content execution results to the content server.

4. The apparatus of claim 1, wherein the virtual convergence gateway server comprises
a multiple-user profile managing unit configured to store user information and user terminal information in order to provide the piece of content according to user's characteristics;
an authentication and user-terminal migration managing unit configured to authenticate the piece of content, perform format conversion on the piece of content, perform an encryption process for the piece of content and manage compatibility and correlation between the user terminals;
a session and user-activity managing unit configured to manage a session activated by each of the user terminals;
one or more virtual terminals configured to provide a thin client environment to the user terminals; and
a content convergence managing unit configured to mix the plurality of pieces of content to generate the mixed content.

5. A method for providing mixed content based on cloud computing; comprising:
in response to a user's content request for a piece of content, checking user information and user terminal information in a multiple-user profile of a virtual convergence gateway server;
transmitting the content request for the piece of content to a content access middleware, and searching a content server to select a plurality of pieces of content using a content searching unit;
allocating one or more virtual terminals to the content server based on the selected piece of content, executing the piece of content in the one or more allocated virtual terminals and transmitting a content call for the content execution results to the content server;
in response to the content call for the content execution results, dynamically allocating the one or more virtual terminals to the content server, executing the selected piece of content in the one or more allocated virtual terminals and providing the content execution results to the content access middleware;
synchronizing the content execution results provided from the content server in a synchronization managing unit and providing synchronized content execution results to the virtual convergence gateway server;
mixing the synchronized content execution results provided from the content access middleware in a content mixing unit so as to generate mixed content;
converting the piece of content into a format to have definition, capacity and pixel number adequate to the user terminal; and
providing the converted mixed content to the user terminal.

6. The method of claim 5, wherein the providing of the converted mixed content further comprises using a split-screen method for dividing a screen of the user terminal into two or more regions.

7. The method of claim 5, wherein the providing of the converted mixed content further comprises using a multi-screen method for displaying a same piece of content on screens of two or more user terminals simultaneously.

8. The method of claim 5, wherein the allocating of the one or more virtual terminals to the content server comprises allocating the one or more virtual terminals using a resource allocation algorithm which employs linear programming and a heuristic technique.

9. The method of claim 8, wherein the linear programming has linear constraints to minimize a number of servers, map each of the one or more virtual terminals, limit a required resource amount of each of the one or more virtual terminals and limit a network delay time,
wherein
a linear constraint to minimize the number of servers is
$$min {\sum }_{p ∈ P} {y}_{p} ,$$
a linear constraint to map each of the one or more virtual terminals is
$${\sum }_{p ∈ P} {x}_{pv} = 1 ∀ v ∈ V ,$$
a linear constraint to limit a required resource amount of each of the one or more virtual terminals is
$${\sum }_{v ∈ V} {u}_{v r} {x}_{p v} \leq {c}_{pr} {y}_{p} ∀ p ∈ P , ∀ r ∈ R ,$$
a linear constraint to limit a network delay time is d_{I}≦T,
a linear constraint to limit overall resource usage is
$${\sum }_{p ∈ P} r u {c}_{pv} {x}_{p v} \leq {T}_{1} ∀ v ∈ V ,$$
and
a linear constraint to adjust CPU resource usage used by a server is
$${\sum }_{p ∈ P} {s}_{p v} {x}_{p v} \leq {T}_{2} ∀ v ∈ V ,$$
wherein
yₚ is the number of servers, χₚᵤ is a variable with respect to a virtual terminal v and a server p, P is a number of physical servers, V is a number of virtual terminals, R is resources including Central Processing Unit (CPU) resources, memory resources, Graphic Processing Unit (GPU) resources and network resources, uᵥᵣ is resource usage of the virtual terminal, cₚᵣ is a resource capacity of the server, d_{I} is a service request delay time, T is a network delay threshold, rucₚᵥ is an amount of resources used by the virtual terminal, sₚᵥ is an amount of CPU resources used by the virtual terminal in the server, T₁ is a threshold of overall resources state, and is a threshold of remaining CPU resources.

10. The method of claim 9, wherein the linear constraint to limit a network delay time of the virtual terminal uses three methods including a non-synchronous integration method, a synchronous integration method and a sequential-service integration method,
wherein
a linear constraint to limit a network delay time of the virtual terminal using the non-synchronous integration method is
$${\sum }_{p ∈ P} {d}_{p {e}_{i}} {x}_{p {v}_{i}} \leq {T}_{{v}_{i}} ∀ {v}_{i} ∈ I ,$$
a linear constraint to limit a network delay time of the virtual terminal using the synchronous integration method is
$${\sum }_{p ∈ P} {d}_{p {e}_{i}} \leq min ( {T}_{{v}_{i}} ) ∀ {v}_{i} ∈ I ,$$
and
a linear constraint to limit a network delay time of the virtual terminal using the sequential-service integration method is
$${\sum }_{p ∈ P} {d}_{p {e}_{1}} {x}_{{pv}_{i}} \leq {T}_{{v}_{1}}$$
$$Given {P}_{1} {\sum }_{p ∈ P} ( {d}_{p {e}_{2}} + {d}_{{p}_{1} p} ) {x}_{{pv}_{2}} \leq {T}_{{v}_{2}} - {T}_{{v}_{1}}$$
$$…$$
$$Given {P}_{n - 1} {\sum }_{p ∈ P} ( {d}_{p {e}_{i}} + {d}_{{p}_{i - 1} p} ) {x}_{{pv}_{i}} \leq {T}_{{v}_{i}} - {T}_{{v}_{i - 1}}$$
wherein,
I is a requested service, dₚₑ_{ᵢ} is a network delay time between a server p and an external server eᵢ, dₚ_{_{i−1}}ₚ is a network delay time between a server and a server pᵢ₋₁, and Tᵥ_{ᵢ} is a limited delay time allocated to a virtual terminal i.
